(19) United States
(12) Patent Application Publication
(10) Pub. No.: US 2018/0047389 A1
(43) Pub. Date: Feb. 15, 2018

(54) APPARATUS AND METHOD FOR RECOGNIZING SPEECH USING ATTENTION-BASED CONTEXT-DEPENDENT ACOUSTIC MODEL

(71) Applicant: ELECTRONICS AND TELECOMMUNICATIONS RESEARCH INSTIT INSTITUTE, Daejeon (KR)

(72) Inventors: Hwa Jeon SONG, Daejeon (KR); Byung Ok KANG, Daejeon (KR); Jeon Gue PARK, Daejeon (KR); Yun Keun LEE, Daejeon (KR); Hyung Bae JEON, Daejeon (KR); Ho Young JUNG, Daejeon (KR)

(73) Assignee: ELECTRONICS AND TELECOMMUNICATIONS RESEARCH INSTITUTE, Daejeon (KR)

(21) Appl. No.: 15/404,298

(22) Filed: Jan. 12, 2017

(30) Foreign Application Priority Data
Aug. 12, 2016 (KR) 10-2016-0102897

(51) Int. Cl. G10L 15/16; G10L 25/87; G10L 15/14

(52) U.S. Cl. CPC G10L 15/16; G10L 15/142; G10L 25/87

(57) ABSTRACT

Provided are an apparatus and method for recognizing speech using an attention-based content-dependent (CD) acoustic model. The apparatus includes a predictive deep neural network (DNN) configured to receive input data from an input layer and output predictive values to a buffer of a first output layer, and a context DNN configured to receive a context window from the first output layer and output a final result value.

### CROSS-REFERENCE TO RELATED APPLICATION

This application claims priority to and the benefit of Korean Patent Application No. 10-2016-0102897, filed on Aug. 12, 2016, the disclosure of which is incorporated herein by reference in its entirety.

### BACKGROUND

### 1. Field of the Invention

The present invention relates to an apparatus and method for recognizing speech, and more particularly, to an apparatus and method, to which a deep neural network (DNN)-hidden Markov model (HMM)-based system is applied, for recognizing speech using an attention-based context-dependent (CD) acoustic model.

### 2. Discussion of Related Art

Recently emerging deep learning technologies and DNN technologies are actively being applied to the speech recognition field. In the case of an acoustic model for speech recognition, there is a trend of changing from an existing Gaussian mixture model (GMM)-HMM model-based system to a DNN-HMM structure.

There are some advantages and disadvantages in using a GMM and a DNN. A DNN allows for freer designation of an output when compared to a GMM. In the case of a GMM-HMM, the model is generally trained without using time information, but in the case of a DNN, a pair of an input and an output is generally clearly configured using alignment information and used for training. Therefore, it is possible for a developer to create a model by arbitrarily determining past, present, and future output values from an input. On the other hand, such training is not easy in a GMM-HMM.

Compared to a GMM, a DNN has a disadvantage in that, it is difficult to apply a technology, such as model analysis, speaker adaptation, etc., to a model after the model is created. Also, DNN training in a DNN-HMM structure has a GMM-HMM structure having a context-dependent (CD) state in which an output probability of the state is changed to a DNN output value. Therefore, the larger the number of states, the more time is consumed to calculate a final output. In particular, a parallel processing computation using a graphics processing unit (GPU), which is advantageous in a DNN, becomes a bottleneck in a GMM.

A DNN-HMM structure used in speech recognition is basically in accordance with a GMM-HMM structure having the CD state. A high-performance GMM-HMM may be obtained by subdividing a basic structure in the CD state, and high-quality alignment information may be obtained through the high-performance GMM-HMM and used for DNN training. This is a basic method of creating a DNN-HMM.

Recently, a method of directly using a context-independent (CI) state without using the CD state through bidirectional long short-term memory recurrent neural network (BiLSTM-RNN) and connectionist temporal classification (CTC) training has been developed and is actively used in Google and so on. Also, combinations of a DNN/RNN and an attention technology are recently being used in various fields.

### SUMMARY OF THE INVENTION

The present invention is directed to providing a method of creating a new context-dependent (CD) acoustic model for making full use of advantages of a deep neural network (DNN) and overcoming disadvantages thereof.

The present invention is not limited to the aforementioned object, and other objects not mentioned above may be clearly understood by those of ordinary skill in the art from the following descriptions.

According to an aspect of the present invention, there is provided an apparatus for recognizing speech using an attention-based CD acoustic model including: a predictive DNN configured to receive input data from an input layer and output predictive values to a buffer of a first output layer; and a context DNN configured to receive a context window from the first output layer and output a final result value.

According to another aspect of the present invention, there is provided a method of recognizing speech using an attention-based CD acoustic model including: receiving a speech signal sequence; converting the speech signal sequence into input data in a vector form; learning weight vectors to calculate a predictive value based on the input data; calculating sums of pieces of the input data to which weights have been applied as predictive values using the input data and the weight vectors; generating a context window from the predictive values; and calculating a final result value from the context window.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of an apparatus for recognizing speech according to an exemplary embodiment of the present invention;

FIG. 2 is an example diagram illustrating a method of recognizing speech using an attention-based context-dependent (CD) acoustic model;

FIG. 3 is a configuration diagram of a multilayer deep neural network (DNN) according to a partial exemplary embodiment of the present invention;

FIGS. 4 and 5 are example diagrams illustrating a method of configuring new CD data from output results of FIG. 2;

FIG. 6 is an example diagram of a DNN that predicts a final output using configured CD data;

FIG. 7 is an example diagram illustrating a method of configuring CD data by sampling some outputs from a multilayer DNN;

FIG. 8 is an example diagram illustrating a method of configuring CD data for an output of a predictive DNN and an input of a context DNN;

FIG. 9 is an example diagram illustrating a prediction method of an artificial neural network;

FIG. 10 is an example diagram illustrating an operating method of a recurrent neural network (RNN);

FIG. 11 is an example diagram illustrating an operating method of a long short-term memory (LSTM);

FIG. 12 is an example diagram showing an operation of an LSTM; and

FIG. 13 is an example diagram illustrating a configuration of a computer system for implementing a method of recognizing speech using an attention-based CD acoustic model according to an exemplary embodiment of the present invention.

### DETAILED DESCRIPTION OF EXEMPLARY EMBODIMENTS

Advantages and features of the present invention and a method of achieving the same should be clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Meanwhile, terminology used herein is for the purpose of describing the embodiments and is not intended to be limiting to the invention. As used in this specification, the singular form of a word includes the plural unless clearly indicated otherwise by context. The term “comprise” and/or “comprising,” when used herein, does not preclude the presence or addition of one or more components, steps, operations, and/or elements other than the stated components, steps, operations, and/or elements.

Hereinafter, exemplary embodiments of the present invention will be described in detail with reference to the accompanying drawings.

The present invention proposes a method of creating a new attention-based context-dependent (CD) acoustic model. According to the method, output information of a plurality of past and future times based on a present time point is predicted using a predictive deep neural network (DNN) 110, and a final output is predicted based on the predicted output information using a context DNN 120. The method has an effective structure for creating a CD acoustic model by combining simple context-independent (CI) models.

In a case of a DNN-hidden Markov model (HMM) created based on a CD Gaussian mixture model (GMM)-HMM, the number of outputs of a DNN varies according to how the CD GMM is created. For example, when the number of states of an HMM is three and a triphone, which is a CD model most widely used based on 46 CI models, is used, the total number of states of the CD GMM-HMM is 3×46×46×46=292,008. In a case of a quinphone, the number of states increases exponentially. However, since there is not enough speech data for training all of the triphones or quinphones, a method of sharing states is used in most cases, but even then the number of states which are finally shared is not small. For example, the number of shared states used to recognize a large vocabulary based on a large database (DB) may be set to be about 10,000.

In an intermediate region of a corresponding speech section obtained by dividing speech data to train a CD model, there is little difference between CD models having the same center phoneme, but there is great difference between CD models in transitional sections connected to other phonemes at both ends of the speech section.

In brief, such a CD model subdivides CI models according to what kinds of phonemes are connected to the front and back of a present CI model. Therefore, the meaning of context dependency may be interpreted differently according to a past phoneme and a future phoneme connected to a present phoneme. In other words, when it is possible to predict a past phone and a future phoneme based on the present, these connections may be interpreted as the meaning of context dependency.

Unlike a GMM, it is possible to adjust a DNN to output a past/present/future value far more freely. Therefore, it is a technical object of the present invention to directly configure CD data from acoustic data using a CI multilayer DNN model having a capability of predicting a past/present/future value and to create a context DNN model capable of directly expressing a CD acoustic space in depth at the present time point using the CD data rather than to separately train CD models.

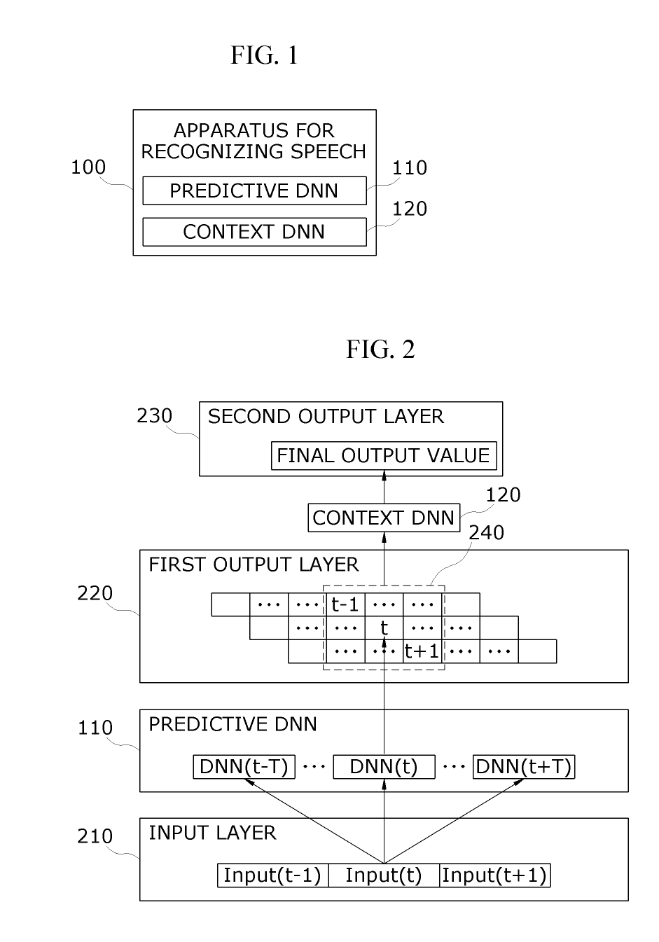

FIG. 1 is a block diagram of an apparatus for recognizing speech according to an exemplary embodiment of the present invention.

An apparatus 100 for recognizing speech according to an exemplary embodiment of the present invention includes the predictive DNN 110 and the context DNN 120.

A DNN denotes a neural network composed of several layers among neural network algorithms. One layer is composed of a plurality of nodes which actually perform calculations. Such a calculation process is designed to simulate a process occurring in neurons constituting a neural network of a human. A general artificial neural network is divided into an input layer, a hidden layer, and an output layer. Input data becomes an input of the input layer, and an output of the input layer becomes an input of the hidden layer. An output of the hidden layer becomes an input of the output layer, and an output of the output layer becomes a final output. A DNN indicates a case in which there are two or more hidden layers.

FIG. 2 is an example diagram illustrating a method of recognizing speech using an attention-based CD acoustic model.

An apparatus for recognizing speech using an attention-based CD acoustic model according to an exemplary embodiment of the present invention includes the predictive DNN 110 and the context DNN 120. The predictive DNN 110 predicts past, present, and future outputs from input data of a present time point. Input(t) included in an input layer 210 of FIG. 2 is input data of the present time point. Predictive DNN nodes DNN(t−T) to DNN(t−1) are used to predict past outputs, and predictive DNN nodes DNN(t+1) to DNN(t+T) are used to predict future outputs. DNN(t) is used to predict a present output.

Predictive values predicted by DNN(t−T), DNN(t), and DNN(t+T) are indicated by an arrow in a corresponding buffer of a first output layer 220.

A series of input data is input from the input layer 210 over time. Input(t−1), input(t), and input(t+1) shown in FIG. 2 are input data which have unit phoneme information. Here, t−1 does not denote a unit of seconds and denotes a time corresponding to a unit time of phonemes. For example, when input data is generated in units of 10 ms, input(t−1) is input data of a time that is 10 ms before input(t) is generated, and input(t+1) is input data of a time that is 10 ms after input(t) is generated. However, generation periods of input data do not necessarily correspond to unit times of phonemes corresponding to respective pieces of the input data. In an exemplary embodiment of the present invention, for example, when the generation periods of input data are 10 ms, unit times of phonemes may be set to 20 ms, and thus the apparatus for recognizing speech may be designed so that consecutive pieces of input data overlap each other by a section of 10 ms. Input data denotes vectors which are extracted as features from unit-specific phonemes for a certain time. A total of 2T+1 predictive values between t−T and t+T are predicted from one piece of input data according to a preset T. Such a prediction is repeatedly performed for each piece of input data.

A buffer having three rows is shown in the first output layer 220 of FIG. 2. An uppermost row shows predictive values of input data at t−1, that is, input(t−1), as blocks. The blocks are a total of 2T+1 predictive values from t−1−T to t−1+T based on t−1. Each predictive value is predicted by each predictive DNN node included in the predictive DNN 110.

Likewise, an intermediate row shows 2T+1 predictive values estimated from input(t), and a lowermost row shows 2T+1 predictive values estimated from input(t+1). The rows are moved left or right so that blocks disposed in the same column have predictive values corresponding to the same time point.

In FIG. 2, a 3×3 block having a present predictive value of input(t) at the center thereof is referred to as a context window 240 and is indicated by a broken line. A size and time point of the context window may be adjusted as necessary.

The context DNN 120 calculates a final output value using the context window as an input.

FIG. 2 is a simplified conceptual diagram of an overall method. The predictive DNN 110 or the context DNN 120 may include more layers.

In FIG. 2, when input data input(t) of a time t obtained by converting a speech signal sequence of recognized actual speech data into vectors is input to the predictive DNN 110 composed of 2T+1 nodes, the predictive DNN nodes calculate as many predictive values as a set number N of output nodes and store the calculated predictive values in a corresponding buffer.

A structure or a shape of the predictive DNN 110 is not limited, and a DNN, a convolutional neural network (CNN), a recurrent neural network (RNN), etc. are representative of the predictive DNN 110. It is possible to configure DNNs having various structures by configuring a predictive DNN with a combination of neural networks.

A number N of DNN output nodes may be arbitrarily set by a developer, but in the present invention, the number N of output nodes is set to the number of CI phonemes so that the meaning of context independency/dependency may be presented. Therefore, DNN(t−T) outputs a probability value of a CI phoneme of the past that is −T before a time point t, DNN(t) outputs a probability value of a CI phoneme of the present time point t, and DNN(t+T) outputs a probability value of a CI phoneme of the future that is +T after the time point t.

In the first output layer 220, a result of predicting the present in the past and a result of predicting the present in the future are shown together based on the present time point t (in a vertical direction of the time point t). When a context size is set to 0 in the context window 240, only a predictive value of the present time point is used, and when the context size is increased, it is possible to use predictive values of past and future time points together. For example, when the context size is 0, the total number of output nodes is (2T+1)×N (N is the number of CI models), and when T is 10 and the number of CI models is 46, dimensionality of a buffer at the present time point t is a total of 966 (=21×46).

In this way, various CD phenomena may be observed by analyzing a configuration of data included in the context window 240. When a size of the context window 240 is increased, it is possible to analyze a larger variety of CD phenomena.

Through the context DNN 120, a final output value of data in the context window may also be used as an HMM state output value. Output nodes of the context DNN 120 corresponding to the number of output nodes used in an existing CD DNN-HMM may be defined for use, or a CI DNN-HMM may be simply be defined for use. Alternatively, a context DNN capable of directly expressing context dependency may be trained using connectionist temporal classification (CTC) without configuring a GMM-HMM. In this case, sufficient CD phenomena are included in the context window 240 that is input data of the context DNN 120. Therefore, even when an output is predicted using a CI model, the context DNN 120 may obtain a CD result, and overall efficiency of a system is improved. For this reason, the context DNN 120 makes a prediction using data which expresses context dependency as an attention-based analysis tool. In other words, a context DNN model is trained to increase discrimination between superior data and inferior data as much as possible by using the superior data and the inferior data in context information together.

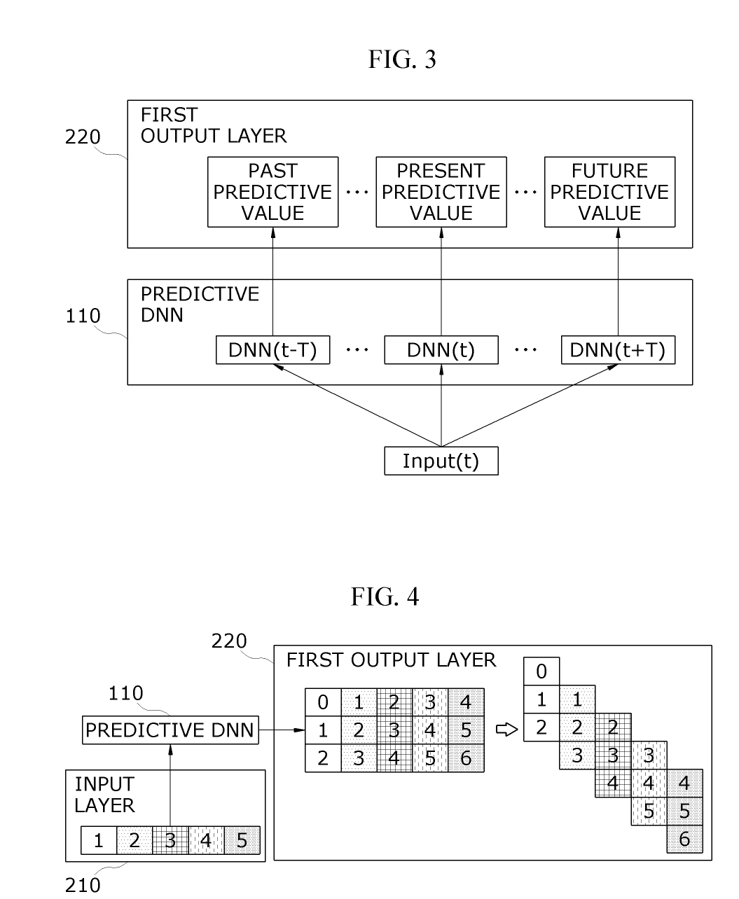

FIG. 3 is a block diagram illustrating an operating method of a multilayer predictive DNN according to a partial exemplary embodiment of the present invention.

For one piece of the input data input(t), the predictive DNN 110 includes 2T+1 individual predictive DNN nodes DNN(t−T) to DNN(t+T), and a value of T may be changed as necessary. Each predictive DNN node predicts a predictive value. In other words, respective predictive DNN nodes predict 2T+1 predictive values corresponding to the past t−T up to the future t+T from the present input data input(t).

There are generally two examples of a method of training the predictive DNN 110 and the context DNN 120. As shown in FIG. 2, in a first example, the predictive DNN 110 may be trained first and the context DNN 120 may be trained using predictive values of the predictive DNN 110. In a second example, the predictive DNN 110 and the context DNN 120 may be trained together by simultaneously using outputs thereof. Besides these examples, training may be performed in various ways according to training methods of a DNN. For example, training may be performed using an RNN, a long short-term memory (LSTM), and so on.

For example, when the predictive DNN 110 and the context DNN 120 are replaced by a bidirectional long short-term memory (BiLSTM) RNN and CTC is used, it is possible to naturally design the context DNN 120 as well as CD data output from the predictive DNN 110 to have a stronger context dependency expression capability for predicting the distant past and future.

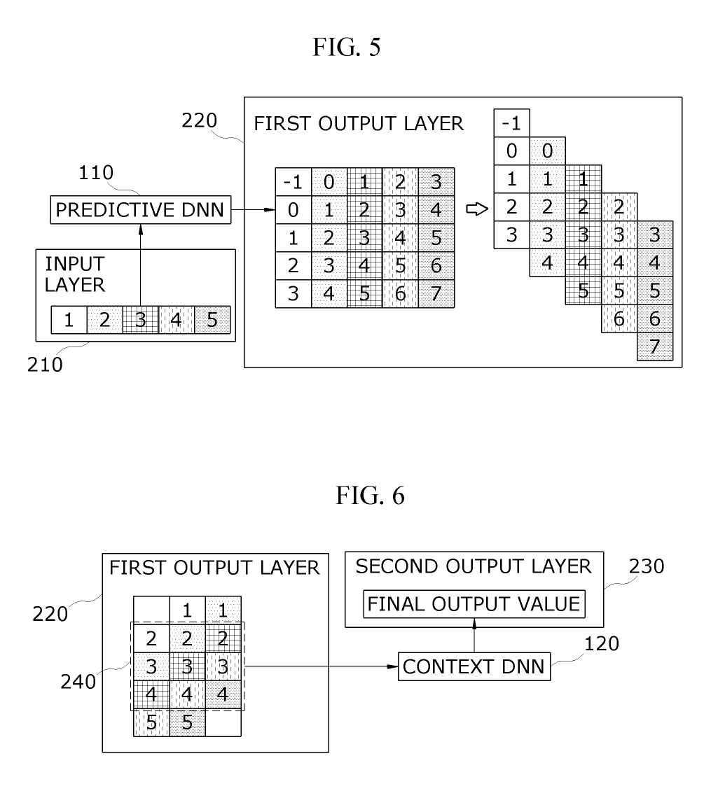

FIGS. 4 and 5 are example diagrams illustrating a method of configuring new CD data from output results of FIG. 2.

FIG. 4 shows a case in which T=1, and FIG. 5 shows a case in which T=2.

Numbers shown in blocks denote time points of respective pieces of data. As shown in FIG. 4, input data is a total of five pieces of time-series speech data. In general, time intervals of units of pieces of speech data may be, for example, about 20 ms, and time intervals of numbers may be set to 10 ms, which is half of the time intervals of the speech data. In other words, a beginning 10 ms of speech data “2” may be the same as an ending 10 ms of speech data “1,” and a beginning 10 ms of speech data “2” may be the same as an ending 10 ms of speech data “3.” However, respective pieces of speech data are obtained by extracting features from original speech data and processing the features through filter banking, and thus do not necessarily overlap with each other.

Predictive values constituting the first output layer 220 are predicted from the input data by the predictive DNN 110. Since T=1 in FIG. 4, there are three predictive values of input data “1,” and the three predictive values are shown as “0,” “1,” and “2” in a first column of a 3×5 table. Likewise, predictive values of input data “2,” “3,” “4,” and “5” are shown in second, third, fourth, and fifth columns of the 3×5 table. Blocks shown on the right of the first output layer 220 are arranged in rows according to predicted time points.

In FIG. 5, since T=2, “1” in input data included in the input layer 210 has a total of five predictive values, which are shown as “−1,” “0,” “1,” “2,” and “3” in a first column in a 5×5 table of the first output layer 220. Blocks shown on the right of the first output layer 220 are arranged in rows according to predicted time points.

FIG. 6 is an example diagram of a DNN that predicts a final output using configured CD data.

FIGS. 4 and 5 show methods of configuring predictive values of the first output layer 220 in the buffer of the first output layer 220 when the size of the context window 240 is T=1 and T=2, respectively. In FIG. 6, the context window 240 is generated by configuring data, which is predictive values of the first output layer 220 of FIG. 4 and predictive values of the first output layer 220 of FIG. 5, in a diagonal direction based on a present time point. Beginning and end blocks having no predictive value are filled with arbitrary data. In general, the blocks are filled with last data or 0.

Specifically, the first output layer 220 of FIG. 6 is generated by arranging the data included in the first output layer 220 of FIG. 4. A process of calculating a final output value using the data included in the first output layer 220 of FIG. 4 as input data of the context DNN 120 is shown. The context window 240 shown in FIG. 6 is centered on a present predictive value of DNN(t) in a case in which t=3. However, a time point may be arbitrarily adjusted as long as it is possible to use data of the first output layer 220 and the data of the first output layer 220 may be used for training.

Since the context window 240 of FIG. 6 includes CD data, it is easy to extract characteristics of a speaker, such as a speech rate, lengthening, shortening, etc., using the CD data, and it is easy to implement a speaker-dependent speech recognition function and a speech recognition function according to the speech rate based on the extracted characteristics. The larger the context window 240, the higher the speech recognition performance.

A method of recognizing speech using an attention-based CD acoustic model includes: an operation of receiving a speech signal sequence; an operation of converting the speech signal sequence into input data in a vector form; an operation of learning weight vectors to calculate a predictive value based on the input data; an operation of calculating sums of pieces of the input data to which weights have been applied as predictive values using the input data and the weight vectors; an operation of generating a context window from the predictive values; and an operation of calculating a final result value from the context window.

In the operation of converting the speech signal sequence, the speech signal sequence may be converted into the input data using a signal having a time-axis element with a preset length and a plurality of preset frequency-band elements in a filter-bank manner.

In the operation of learning the weight vectors, a weight of a reference weight vector which has been previously set by learning is increased based on a time axis, and the weight vectors are learned so that a value calculated through back-propagation corresponds to the input data.

In the operation of calculating the final result value from the context window, the final result value may be calculated using a speaker-dependent method in which a method of calculating a final result value from calculated values of a first output layer varies according to a speaker, or the final result value may be calculated using different methods of calculating the final result value from the calculated values of the first output layer using an attention-based DNN according to a speech rate.

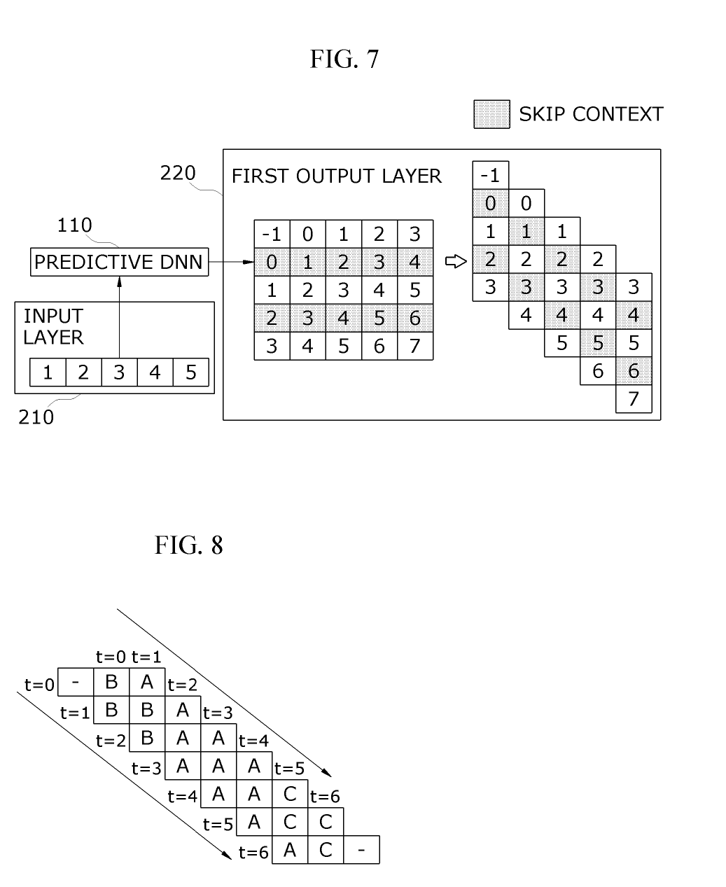

FIG. 7 is an example diagram illustrating a method of configuring CD data by sampling some outputs from a predictive DNN.

T=2 in FIG. 5, and FIG. 7 shows a predictive DNN in the same form as in the case in which T=2. However, in the predictive DNN, DNN(t−1) and DNN(t+1) do not make a prediction, and only DNN(t−2), DNN(t), and DNN(t+2) make predictions so that efficiency may be improved. Since input time intervals of input data are frequently set to half of time intervals of pieces of data, a prediction may be made without executing some predictive DNN nodes at the time intervals of the input data to remove overlapping time intervals. Then, empty blocks in the context window may be filled using interpolation. Since it is highly likely that neighboring neural networks output similar results, overall efficiency of a system may be improved by not using some predictive DNN nodes, and output dimensions may be reduced by excluding skip values, or skip values may be obtained using interpolation with nearby values.

FIG. 8 is an example diagram illustrating a method of configuring CD data for an output of a multilayer predictive DNN and an input of a context DNN.

When a CI model “A” has the highest probability upon prediction of present output information in the past, present, and future, it is possible to assume that speech data at the time point t is a region in which a phoneme “A” is maintained (t=2 to t=4 in a vertical-axis direction). When a vocalization is made at a normal rate, there will be a relatively large number of regions in which A is superior. On the other hand, when a speech rate of a speaker is high, a phonemic section that is constantly maintained will be significantly short, and thus there will be a relatively small number of regions in which A is superior in predictions about present output information made in the past, present, and future.

Also, when the CI model “A” has the highest probability upon prediction of present output information in the past and a CI model “B” has the highest probability upon prediction of present output information in the present and future, it is highly likely that B is changed to A (t=1 in the vertical-axis direction) in a corresponding region. Subsequently, when a CI model “C” has the highest probability upon prediction of present output information in the past and present and the CI model “A” has the highest probability upon prediction of present output information in the future, it is highly likely that A is changed to C (t=5 in the vertical-axis direction) in a corresponding region.

By calculating past, present, and future predictive values based on phonemes input at time intervals as described above, it is possible to set an output value for an input value in a certain time region. For example, as shown in FIG. 8, “A,” “A,” “A,” “A,” “C,” “C,” and “-” (“-” is generally replaced with an arbitrary value) in last blocks of respective rows may be set as output values using “-,” “B,” “B,” “A,” “A,” “A,” and “A” in first blocks of the respective rows as input values, or vice versa. Various speech recognition results may be extracted using given CD data and a regular pattern, and speech recognition characteristic information may be rapidly and efficiently extracted from a known pattern.

When it is not possible to find superiority among prediction results of present output information made in the past, present, and future and there is almost no superior phoneme, it is highly likely that noise or an unclear utterance is in a corresponding region. Such a characteristic is frequently generated in a natural language utterance, and may be analyzed using a speech recognition method according to an exemplary embodiment of the present invention.

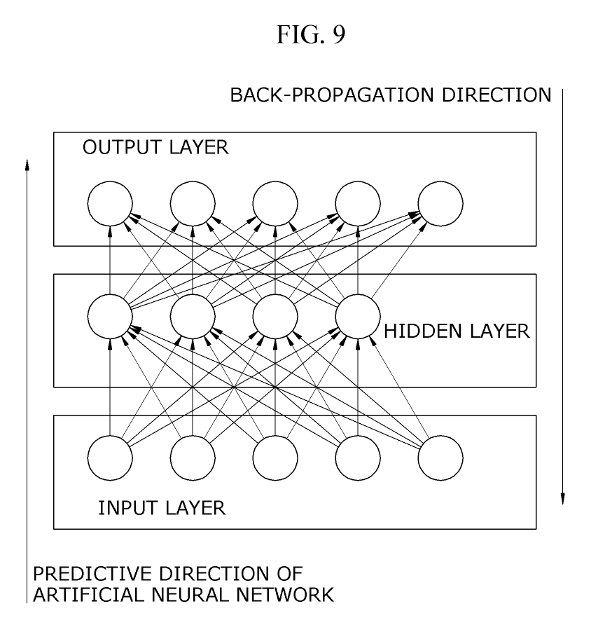

FIG. 9 is an example diagram illustrating a prediction method of an artificial neural network.

An artificial neural network includes an input layer composed of initial input data and an output layer composed of final output data, and includes a hidden layer as an intermediate layer which calculates output data from the input data. There is at least one hidden layer, and an artificial neural network including two or more hidden layers is referred to as a DNN. Actual calculations are performed by nodes existing in each layer, and each node may perform a calculation based on an output value of another node connected to the node through a connection line.

As shown in FIG. 9, pieces of input data or nodes in the same layer do not affect each other in principle, and each layer exchanges data with a node of an adjacent upper or lower layer as an input value or output value.

In FIG. 9, all nodes in adjacent layers are connected to each other through connection lines, but there may be no connection line between nodes in adjacent layers as necessary. When there is no connection line, a weight for a corresponding input value may be set to 0 to process the input value.

When a result value of the output layer is predicted from the input layer in a prediction direction of the artificial neural network, an input value may be predicted from result values of a training process. In an artificial neural network, input values and output values are generally not in a one-to-one relationship, and thus it is not possible to recover an input layer as it is when using an output layer. However, when input data calculated from a result value by a back-propagation algorithm in consideration of a prediction algorithm differs from initial input data, the prediction of the artificial neural network may be considered to be inaccurate. Therefore, training may be performed after a prediction coefficient is changed so that input data calculated under a constraint condition becomes similar to the initial input data.

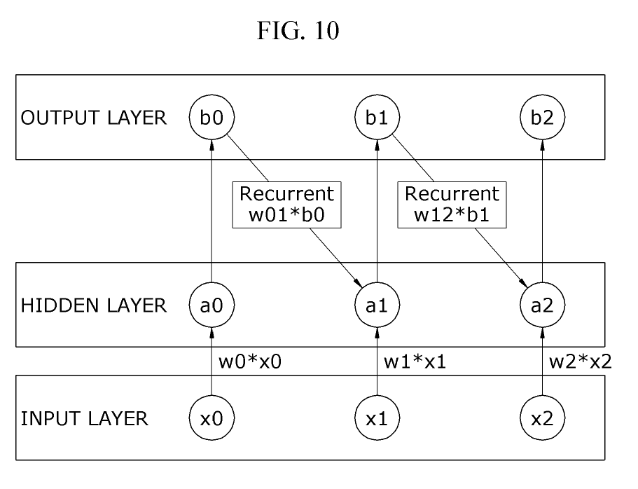

FIG. 10 is an example diagram illustrating an operating method of an RNN.

Unlike the artificial neural network of FIG. 9, an RNN denotes a method of predicting a0 solely from x0, calculating an output value b0 based on a0, and reusing b0 to predict a1 when there are pieces of input data x0, x1, and x2; input in chronological order.

The artificial neural network of FIG. 9 has been described assuming that a plurality of pieces of input data are simultaneously input. However, in a case of time-series input data, it is possible to make a prediction after all of the data is input, and thus an output value may be calculated using an RNN method for processing the time-series inputs.

It is effective to train an artificial neural network using the method of FIG. 9 and to actually make a prediction based on the training using the RNN method shown in FIG. 10.

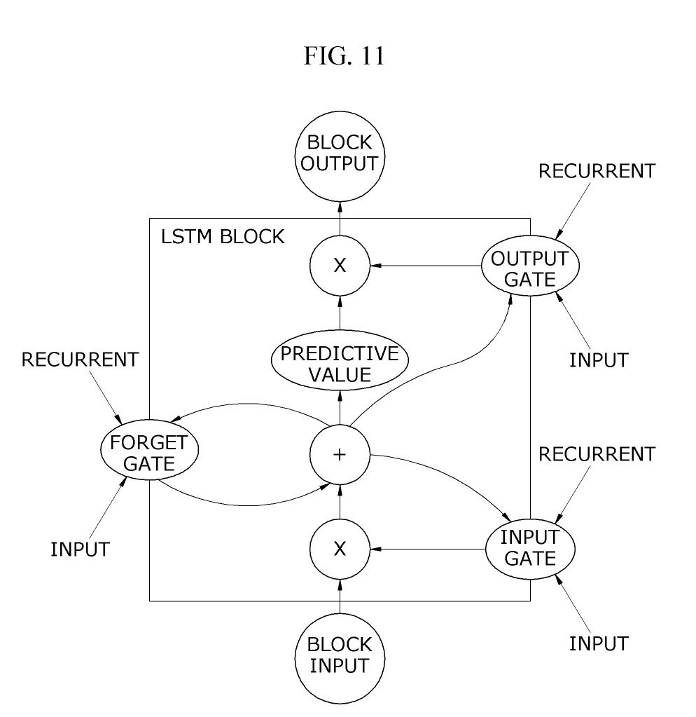

FIG. 11 is an example diagram illustrating an operating method of an LSTM.

An LSTM denotes a kind of RNN method in which a result value is predicted using forget gates instead of weights of an RNN. In a case in which time-series input data is predicted, past data may be processed using the RNN method to process data in sequence. In this case, old data is reduced according to a weight thereof, and there is a problem in that the old data has a value of 0 and is not applied any more regardless of a weight thereof after a certain stage.

In the case of an LSTM, addition is used instead of multiplication, and thus there is an advantage in that a recurrent input value does not become 0. However, an old recurrent input value may continuously affect a recent predictive value, and this problem may be controlled using a forget gate. Such control is trained to adjust a coefficient.

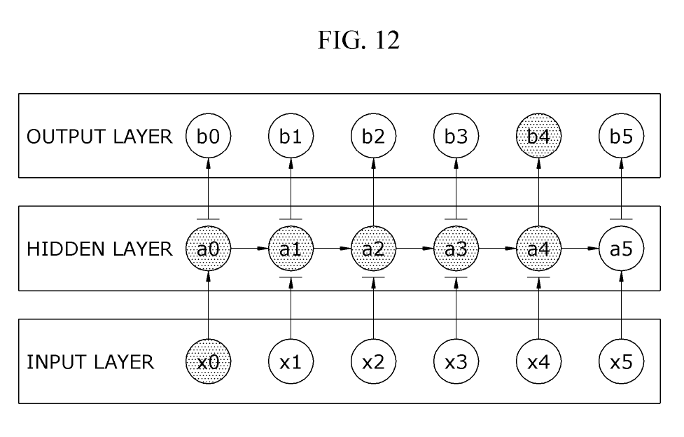

FIG. 12 is an example diagram showing an operation of an LSTM.

When there are pieces of time-series input data x0, x1, x2, x3, x4, and x5, an independent neural network may predict output data of an output layer from input data of an input layer in the vertical-axis direction. However, when a forget gate of an LSTM is employed, a DNN may operate in a flow shown in FIG. 12. b0 is predicted from a0 but is not applied to a1 due to the forget gate. Also, x1 is not used to predict a1 (x1 is blocked by the forget gate). These are indicated by a line between a0 and b0 and a line between x1 and a1. Likewise, b1 is not applied to a2. a2 is predicted from a1 and x2, b2 is predicted from a2, and b2 is used to predict a3. In the speech recognition field, by extracting characteristics of lengthening, shortening, and speech rate and applying the extracted characteristics to an LSTM, it is possible to improve speech recognition performance.

As described above regarding the configuration and operation, according to exemplary embodiments of the present invention, it is possible to efficiently create an acoustic model that expresses a CD phenomenon using a multilayer CI predictive DNN for predicting the past/present/future. In other words, it takes much time for an existing acoustic model output node having many outputs to calculate a softmax value corresponding to a final probability. In particular, even a graphics processing unit (GPU)-based system which is advantageous for parallel processing consumes much time when calculating softmax values for many DNN output nodes. On the other hand, exemplary embodiments of the present invention involve a small number of output nodes, and thus overall efficiency of a system may be considerably improved.

While an existing CI acoustic model is intended to create a model that has a highest probability at an output corresponding to present input data, exemplary embodiments of the present invention make it possible to predict the past/present/future at a present time point, configure actual CD data using the predictive information, and apply the CD data to a present output. This method facilitates adjustment of an acoustic model. A representative technical application of the method is a speaker adaptation technology. In practice, it is uneasy to apply an existing speaker adaptation technology to an existing DNN. However, in a model according to exemplary embodiments of the present invention, speakers have different distributions of CD data, and thus it is possible to easily create a speaker-dependent model by applying adaptation data to only the context DNN 120 and adjusting the model. Also, since it is possible to set the number of final output nodes of the context DNN 120 to the number of CI phonemes, effective speaker adaptation is possible even when there is a small amount of adaptation data.

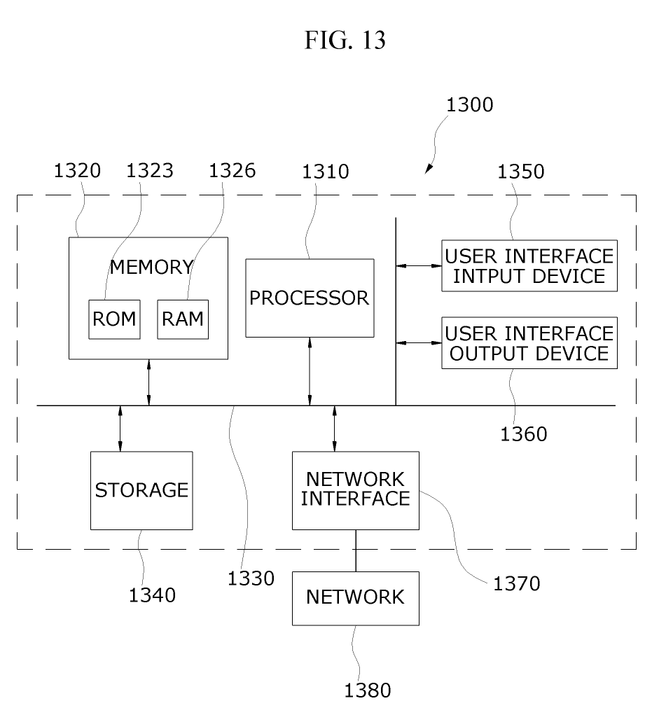

FIG. 13 is an example diagram illustrating a configuration of a computer system for implementing a method of recognizing speech using an attention-based CD acoustic model according to an exemplary embodiment of the present invention.

A method of recognizing speech using an attention-based CD acoustic model according to an exemplary embodiment of the present invention may be implemented by a computer system 1300 or recorded in a recording medium. As shown in FIG. 13, the computer system 1300 may include at least one processor 1310, a memory 1320, a user input device 1350, a data communication bus 1330, a user output device 1360, and a storage 1340. Each of the aforementioned components performs data communication through the data communication bus 1330.

The computer system 1300 may further include a network interface 1370 connected to a network 1380. The processor 1310 may be a central processing unit (CPU) or a semiconductor device which processes instructions stored in the memory 1320 and/or the storage 1340.

The memory 1320 and the storage 1340 may include various forms of volatile or non-volatile storage media. For example, the memory 1320 may include a read-only memory (ROM) 1323 and a random access memory (RAM) 1326.

Therefore, a method of recognizing speech using an attention-based CD acoustic model according to an exemplary embodiment of the present invention may be implemented as a method executable by a computer. When the method of recognizing speech using an attention-based CD acoustic model according to an exemplary embodiment of the present invention is performed by a computing device, an operating method according to the present invention may be performed through computer-readable instructions.

Meanwhile, the above-described method of recognizing speech using an attention-based CD acoustic model according to an exemplary embodiment of the present invention may be implemented as a computer-readable code in a computer-readable recording medium. The computer-readable recording medium includes all types of recording media in which data readable by a computer system is stored. Examples of the computer-readable recording medium may be a ROM, a RAM, a magnetic tape, a magnetic disk, a flash memory, an optical data storage device, and so on. Also, the computer-readable recording medium may be distributed in computer systems connected via a computer communication network so that the computer-readable recording medium may be stored and executed as codes readable in a distributed manner.

According to exemplary embodiments of the present invention, it is possible to reduce the number of output nodes even while using a CD DNN, and thus overall efficiency of a system is improved.

Since the number of final output nodes may be set to be the number of CI phonemes, it is possible to create a speaker-dependent model using adaptive data on only a CD DNN. Also, it is possible to build a strong context DNN capable of predicting more past and future output values by using an LSTM and CTC.

According to exemplary embodiment of the present invention, compared to a related art, a smaller number of sound-dependent models are created, and thus a recognition time is reduced. Also, predictive information of various times may be easily used to process speaker adaptation and speech in a natural language.

The above description of the present invention is exemplary, and those of ordinary skill in the art should appreciate that the present invention can be easily carried out in other detailed forms without changing the technical spirit or essential characteristics of the present invention. Therefore, it should be noted that the embodiments described above are exemplary in all aspects and are not restrictive.

It should also be noted that the scope of the present invention is defined by the claims rather than the description of the present invention, and the meanings and ranges of the claims and all modifications derived from the concept of equivalents fall within the scope of the present invention.

What is claimed is:

1. An apparatus for recognizing speech using an attention-based context-dependent (CD) acoustic model, the apparatus comprising:
a predictive deep neural network (DNN) configured to receive input data from an input layer and output predictive values to a buffer of a first output layer; and
a context DNN configured to receive a context window from the first output layer and output a final result value.

2. The apparatus of claim 1, wherein the predictive DNN includes at least one of a DNN, a convolutional neural network (CNN), a recurrent neural network (RNN), and a bidirectional long short-term memory (BiLSTM).

3. The apparatus of claim 1, wherein the predictive DNN outputs the predictive values to the buffer of the first output layer according to a preset size of the context window and generates the context window by arranging the output predictive values so that time points of the predictive values are identical in a horizontal axis, and
the context DNN is trained to predict a final output value using the context window as input data and predicts an output value based on the training.

4. The apparatus of claim 1, wherein the predictive DNN includes at least one individual predictive DNN node, and
the individual predictive DNN node generates the context window using the predictive values predicted from the input data.

5. The apparatus of claim 1, wherein the predictive DNN makes a prediction by regularly skipping some of the predictive values.

6. The apparatus of claim 5, wherein the context DNN calculates the skipped predictive values using interpolation with nearby predictive values.

7. A method of recognizing speech using an attention-based context-dependent (CD) acoustic model, the method comprising:
receiving a speech signal sequence;
converting the speech signal sequence into input data in a vector form;
learning weight vectors to calculate a predictive value based on the input data;
calculating sums of pieces of the input data to which weights have been applied as predictive values using the input data and the weight vectors;
generating a context window from the predictive values; and
calculating a final result value from the context window.

8. The method of claim 7, wherein the converting of the speech signal sequence includes converting the speech signal sequence into the input data using a signal having a time-axis element of a preset length and a plurality of preset frequency-band elements in a filter-bank manner.

9. The method of claim 7, wherein the learning of the weight vectors includes increasing a weight of a reference weight vector which has been previously set by learning based on a time axis, and learning the weight vectors so that a value calculated through back-propagation corresponds to the input data.

10. The method of claim 7, wherein the calculating of the final result value from the context window includes calculating the final result value using a speaker-dependent method in which a method of calculating a final result value from calculated values of a first output layer varies according to a speaker.

11. The method of claim 7, wherein the calculating of the final result value from the context window includes calculating the final result value using different methods of calculating a final result value from calculated values of a first output layer using an attention-based deep neural network (DNN) according to a speech rate.

12. The method of claim 7, wherein the calculating of the sums of pieces of the input data includes calculating the sums of pieces of the input data using at least one of a deep neural network (DNN), a convolutional neural network (CNN), a recurrent neural network (RNN), and a long short-term memory (LSTM).
